(19) United States
(12) Patent Application Publication
(10) Pub. No.: US 2014/0376560 A1
(43) Pub. Date: Dec. 25, 2014

(54) LOGICAL SWITCH

(71) Applicant: Microsoft Corporation, Redmond, WA (US)

(72) Inventors: Pradeep Senniappan, Redmond, WA (US); Karthikeyan Nenmeli Ravichandran, Bellevue, WA (US); Natalia Valeryevna Varava, Bellevue, WA (US); Gregory M. Cusanza, Redmond, WA (US)

(21) Appl. No.: 13/925,551

(22) Filed: Jun. 24, 2013

(51) Int. Cl. H04L 12/947

(52) U.S. Cl. CPC H04L 49/25
USPC 370/401

(57) ABSTRACT

Configuring third party solutions to operate with virtual machines and virtual switches in a distributed network environment. The method includes receiving information at a logical switch about third party solutions in a distributed network. The method further includes receiving information at the logical switch about requirements for virtual components of the distributed network. The method further includes the logical switch automatically configuring third party solutions in the distributed network to meet the requirements for the virtual components of the distributed network.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Some computing functionality is implemented in the context of distributed computing and virtualization as implemented in datacenters. In virtualization scenarios, virtual computing hardware is implemented using actual physical hardware. For example, several virtual machines may be installed on a physical machine or set of physical machines interconnected with physical networking hardware. Further, the virtual machines may be interconnected using virtual network adapters and virtual switches. However, in many cases the virtual switches make use of an actual physical switch to accomplish communication between different virtual machines that requires communication between different physical machines.

Thus, virtual networks in a datacenter typically have various types of physical server hardware, physical network interface cards (nics) on host physical machines, physical top of rack (TOR) switches and network services configurations in their environments. Administrators currently configure this physical hardware independently, one piece at a time. This can be error prone and time consuming as an administrator needs to manually maintain consistency in such configurations across all virtualization hosts and switches these hosts are connected to in order to enable a) basic connectivity functions for virtualized workloads; b) adequate availability of physical nics and switches hosts are connected to; and c) VM migration capabilities across hosts.

Additionally, tenants of a datacenter hosting a virtual network for the tenant today have to configure virtual nics (vNics) of their virtual machines (VMs) one by one.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a distributed computing environment. The method includes acts for configuring third party solutions to operate with virtual machines and virtual switches in a distributed network environment. The method includes receiving information at a logical switch about third party solutions in a distributed network. The method further includes receiving information at the logical switch about requirements for virtual components of the distributed network. The method further includes the logical switch automatically configuring third party solutions in the distributed network to meet the requirements for the virtual components of the distributed network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a virtualization fabric; and

FIG. 2 illustrates a method of configuring third party solutions to operate with virtual machines in a distributed network environment.

### DETAILED DESCRIPTION

Embodiments described herein implement what is referred to herein as a logical switch. A logical switch centralizes and simplifies virtual network provisioning, administration, and monitoring using network aggregation. In particular, an administrator can interact with the logical switch to define what functionality should be supported in a virtual network. The logical switch can be connected to third party solutions, such as physical hardware devices, software solutions or combinations thereof, such as switches, TOR switches, forwarding hardware and/or applications, monitoring hardware and/or applications, quality of service hardware and/or applications, firewall hardware and/or applications, security gateway hardware and/or applications functions, DOS attack function. The logical switch can then automatically, configure network hardware to allow the network hardware to meet virtual system requirements or to enable additional functionality. For example, the logical switch could be used to configure solutions to create or extend forwarding functionality, monitoring functionality, firewall functionality, DOS attack remediation, IP allocation and management, performance acceleration, gateway functions, etc.

For example, an administrator can indicate that a virtual network should support certain forwarding, bandwidth, filtering, etc. parameters. The administrator can configure these parameters one time in a logical switch user interface. The logical switch can then be responsible for ensuring that all third party solutions, such as physical network hardware and/or software solutions plugged into the logical switch are configured to support such parameters. This allows for easy deployment and migration of workloads across a fabric as there are assurances that the various portions of the fabric support the desired parameters by automatic configuration by the logical switch without an administrator needing to configure each hardware device individually. Additionally, when a solution goes out of compliance with the parameters, the logical switch can automatically, without network administrator interaction, cause the solution to be brought back into compliance and/or alert an administrator if the solution cannot be brought back into compliance. Further, when new solutions are added to the fabric and connected to the logical switch, the logical switch can automatically configure the solutions to be compliant with the specified parameters without a network administrator needing to manually configure the solutions individually.

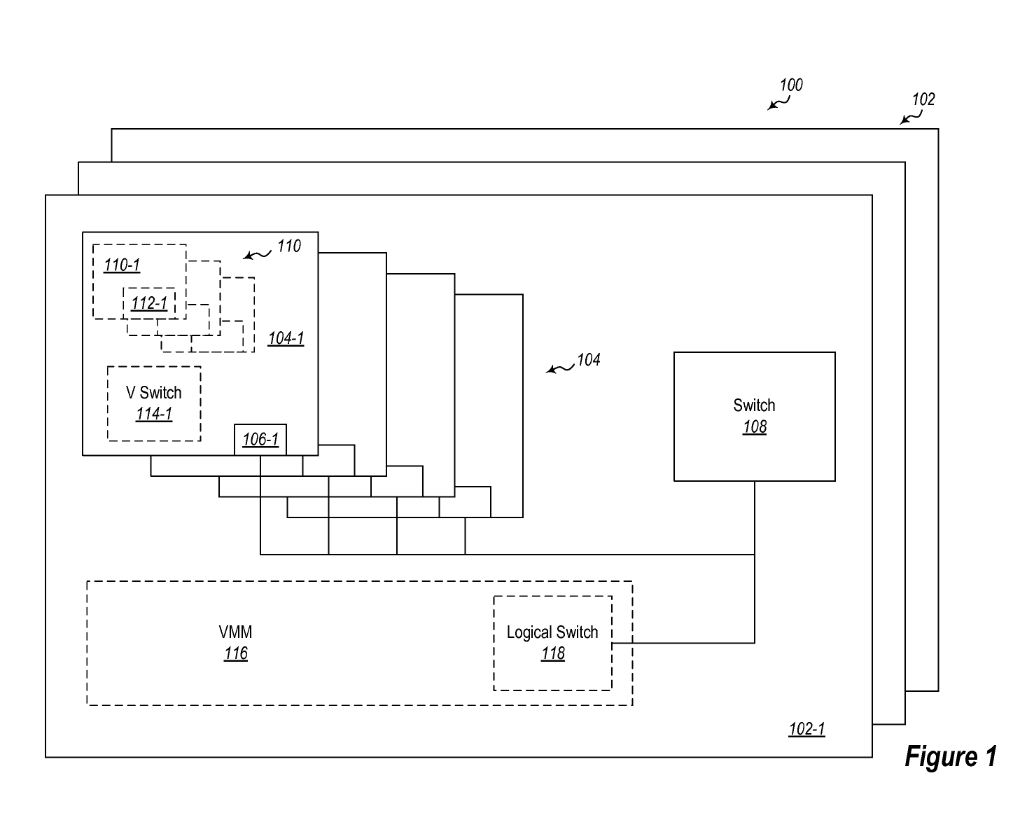

Referring now to FIG. 1, an example is illustrated. FIG. 1 illustrates a distributed network topology fabric 100. Within the distributed network topology fabric 100 is a set 102 of datacenters. While three datacenters are illustrated in the set 102, it should be appreciated that virtually any number of datacenters may be implemented within a distributed network topology fabric. Further, the datacenters may be of similar or different types of datacenters. For example, in one embodiment, a single private datacenter under virtually complete control of an enterprise may be implemented. In another example, multiple private datacenters under virtually complete control of an enterprise may be implemented. In yet another example, a datacenter may be a public cloud datacenter under the control of a hosting entity, but which hosts tenants' virtual networks. In yet another alternative embodiment, an enterprise may use a combination of private cloud data center(s) and public cloud data center(s). Etc.

FIG. 1 illustrates, for example, a datacenter 102-1. At the datacenter 102-1, is a combination of physical components and virtual components. In particular, FIG. 1 illustrates a set 104 of physical host machines. Each of the physical host machines includes a physical network interface card (nic), such as the nic 106-1 illustrated on the physical host machine 104-1. The nics are connected to a physical switch 108 that connects the physical host machines in the datacenter 102-1. The switch 108 can also connect the physical host machines to other datacenters or other hardware and/or devices external to the datacenter 102-1.

FIG. 1 further illustrates various virtual components implemented at the datacenter 102-1. For example, the physical host machine 104-1 hosts a set 110 of virtual machines. In the illustrated example, virtual machine 110-1 also includes a virtual network interface card (vnic) 112-1. Each of the virtual machines includes a vnic connected to the virtual switch 114-1 that facilitates communication to and from virtual machines.

FIG. 1 further illustrates a virtual switch 114-1 on the host machine 104-1. Each host machine includes one or more virtual switches to enable communication between virtual machines on the same host and to components off of a given host. The virtual switch leverages the capabilities of the physical switch 108 to enable communication between physical components.

FIG. 1 further illustrates a virtual machine monitor (VMM) 116. The VMM 116 is a server that may be used to place and configure virtual components in the datacenter 102-1. The VMM 116 may be implemented using one or more of the physical host machines in the set 104 or on some other available hardware device. Additionally, the physical switches may support functionality, and such functionality needs to be enabled if desired for use by a virtual components. Similarly, for vnics to support certain functionality, such functionality needs to be enabled by the underlying physical nics.

Ordinarily, configuration of physical hardware would be performed by an administrator interacting with the devices individually to configure devices in the data center 102-1. Further, placement of virtual components (such as virtual machines), and migration of virtual components as physical hardware changes or failures in the network would ordinarily be performed by administrator interaction with the VMM 116. However, embodiments herein implement a logical switch 118 implemented on top of the virtual switch 114 as part of the VMM 116 that can automatically configure and monitor aspects for network functionality, such as connectivity and capabilities, in a virtualized datacenter.

A logical switch is a scalable, pluggable, and extensible virtual network services platform that that supports third party network services to plug into the key virtual machine (VM) and virtual networking operations. The integration with third party solutions (including hardware devices and/or software solutions) can be enabled on various levels. For example, in some embodiments the logical switch may be configured to interact with third party solutions (hardware and/or software) by using a plugin. The plugin is a server side solution deployed at the VMM that allows the logical switch 118 to communicate directly with the third party solutions. In particular, third parties provide plugins that can be installed on the VMM that allows for communication with application programming interfaces (APIs) at the solutions provided by the third parties. The VMM invokes third party code provided by the plugin.

Alternatively, host level extensions may be implemented. In particular, drivers can be installed at the hosts in the set 104 of hosts. This allows the hosts to interact with third party solutions.

In yet another alternative embodiment, third parties can provide interface extensions that can be plugged into the user interface portion of the VMM. Thus, administrators can configure third party solutions using interface components provided by third party solution providers, but integrated into the native VMM configuration interface.

In yet another embodiments, native hardware APIs may be used. In particular, the hardware may support certain APIs and the VMM can be configured to communicate natively to the third party solutions. For example, a VMM may be configured to communicate natively to TOR switches, VPN and NAT gateways, load balancers, and the like.

The virtual components are limited in their capabilities by what the physical components can provide. For example, the virtual switch 114-1 can provide functionality that is enabled by the physical switch 108. The logical switch 118 can determine and configure physical component properties, virtual component requirements, and match virtual component requirements to physical component (or other third party solution) capabilities. In particular, embodiments can implement network classification that is independent from a VM network, facilitated by the logical switch. This allows fine-tuning networking capabilities that VMs demand and at the same time allows an administrator to move VM workloads across the datacenter to match these demands to the capabilities of the underlying networking equipment.

Configuration and monitoring of aspects of network functions (e.g. connectivity and capability) in a virtualized datacenter can be done at a central place, i.e. at the logical switch. The logical switch functions as a single virtual switch across all hosts plugged into this logical switch 118.

Embodiments provide simplified extensibility. In particular a logical switch 118 is built on top of an extensible virtual switch 114 and allows combining value-add services enabled by various network services. For example, an administrator can provide configuration in the logical switch to enable forwarding functionality, monitoring functionality, firewall functionality, DOS attack remediation, IP allocation and management, performance acceleration, gateway functions, etc. The logical switch coordinates network connectivity and policy management across entities plugged into it. It also enables servicing functions (e.g. version management, maintenance) across a distributed environment.

For example the logical switch 118 may use the native virtual switch 114 for packet forwarding, third party switch extension for packet monitoring and an IP address management service for IP allocation management functions.

Embodiments may implement network topology and connectivity discovery. Virtual network connectivity discovery in enabled by the logical switch, in combination with the functionality of physical and/or virtual networking equipment. Network connectivity is learned from a network topology that is either declared by an administrator or discovered by the logical switch querying various physical and virtual components in the network. Alternatively or additionally, network topology could be published by third parties via logical switch integration. In particular, the logical switch may include APIs that allows third party equipment to declare functionality that is enabled and/or being implemented. A topology published by one party or entered into the VMM 116 can be shared across multiple parties managing the same portion of the datacenter. This further lowers the entry point for third parties to innovate on top of the VMM 116 virtualization enabled datacenters.

Embodiments may enable advanced compliance capabilities. In particular, the VMM 116 actively monitors the configuration of the physical environment enabling the logical switch 118 to detect the physical environment's health, availability and utilization. This may include, for example, VLAN, PVLAN, and other settings on TOR physical switches to which hosts are connected, physical NIC and NIC teaming parameters, management and other host vNics, third party virtual switch extensions that are part of the logical switch and VM vNics attached to the logical switch.

In a condition when either the configuration of a networking entity deviates from the desired state, or the health of the networking entity that is a part of a logical switch is affected, the state of an affected entity is flagged as incompliant providing a relevant detailed description of the problem detected and an alert is sent to an administrator. The effect of such conditions on a larger set of operations enabled by the logical switch is calculated. Notably, a failure\incompliance in one subcomponent can affect the state of a larger system.

In addition to flagging incompliance and alerting the administrator, the VMM 116 may additionally or alternatively support a) automatic (built-in and enabled by third parties) and manual remediation of incompliance for various conditions; b) evaluating the larger impact of incompliance via aggregation; c) avoiding placing workloads on incompatible virtual and physical equipment. In this way the logical switch can either attempt to remediate solutions that are out of compliance, and/or alter a network administrator of such non-compliance.

Embodiments enable division of responsibilities between capability and connectivity. The logical switch matches network capabilities and connectivity requested by the virtual workloads to the underlying capabilities and connectivity enabled by the physical infrastructure. This abstracts workloads from the specifics of the fulfilling such requests by the physical environment.

The logical switch platform supports dynamic changes in both physical and virtual networks. It also allows tenants to define and manage their own networks. For example, a tenant can define L3 (IP space) for their networks, the VMM and a third party plugins can jointly enable L2 isolation for such networks.

Embodiments may enable effective datacenter utilization. VM placement in a datacenter can take into account what logical switch can provide connectivity and capability demanded by the VM. Embodiments can also find a healthy host that can meet VM requirements at VM deployment or migration time. The logical switch allows configuring the physical environment in a more dynamic and optimal fashion where the environment can be provisioned on demand instead of being statically overprovisioned ahead of time for both network virtualization-based and even VLAN-based VM workloads.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

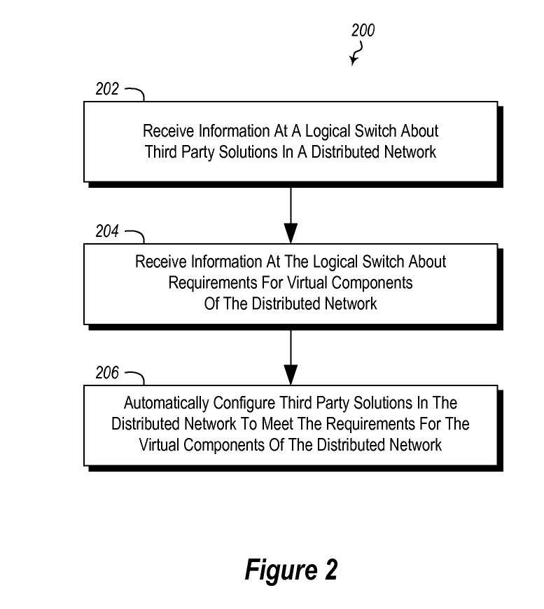

Referring now to FIG. 2, a method 200 is illustrated. The method 200 may be practiced in a distributed computing environment and includes acts for configuring third party solutions to operate with virtual machines in a distributed network environment. The method includes receiving information at a logical switch about third party solutions in a distributed network (act 202). For example, the logical switch 118 may receive information about physical switches, TOR switches, routers, gateways, load balancers, etc.

The method 200 further includes receiving information at the logical switch about requirements for virtual components of the distributed network (act 204). For example, the logical switch 118 may receive information about functionality and/or performance desired from the virtual components. For example, the logical switch may include or be coupled to a user interface that allows an administrator to specify certain forwarding functionality, monitoring functionality, firewall functionality, DOS attack remediation, IP allocation and management, performance acceleration, gateway functions, etc.

The method 200 further includes the logical switch automatically configuring third party solutions in the distributed network to meet the requirements for the virtual components of the distributed network (act 206). For example, the logical switch can coordinates network connectivity and policy management across entities plugged into it to accomplish the specified functionality. In particular, the logical switch can configure third-party solutions to achieve the desired functionality.

As noted above, the method 200 may be practiced where receiving information at a logical switch about third party solutions in a distributed network is performed by the logical switch communicating with the third party solutions and the third party solutions providing the information about the third party solutions directly to the logical switch. Alternatively or additionally, the method 200 may be practiced where receiving information at a logical switch about third party solutions in a distributed network is performed by the logical switch receiving configuration metadata from a network administrator.

With respect to receiving information about requirements for virtual components, the method 200 may be practiced where receiving information at the logical switch about requirements for virtual components of the distributed network comprises receiving information about requirements for virtual components of the distributed network in requirement metadata from a network administrator.

The method 200 may be practiced where the logical switch automatically configuring third party solutions in the distributed network to meet the requirements for the virtual components of the distributed network comprises the logical switch directly configuring third party solutions by communicating with the third party solutions using native third party solution protocols. For example, communicating with third party solutions using third party solution protocols may include the logical switch communicating using a plug-in at the logical switch that enables the plug-in to communicate directly with third party solutions in third party solution's native protocol. Alternatively or additionally, the method of claim 5, wherein communicating with third party solutions using third party solution protocols comprises the logical switch communicating directly with third party solutions using APIs exposed by the third party solutions.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a distributed computing environment, a method of configuring third party solutions to operate with virtual machines in a distributed network environment, the method comprising:
receiving information at a logical switch about third party solutions in a distributed network;
receiving information at the logical switch about requirements for virtual components of the distributed network; and
the logical switch automatically configuring third party solutions in the distributed network to meet the requirements for the virtual components of the distributed network.

2. The method of claim 1, wherein receiving information at a logical switch about third party solutions in a distributed network is performed by the logical switch communicating with the third party solutions and the third party solutions providing the information about the third party solutions directly to the logical switch.

3. The method of claim 1, wherein receiving information at a logical switch about third party solutions in a distributed network is performed by the logical switch receiving configuration metadata from a network administrator.

4. The method of claim 1, wherein receiving information at the logical switch about requirements for virtual components of the distributed network comprises receiving information about requirements for virtual components of the distributed network in requirement metadata from a network administrator.

5. The method of claim 1 wherein the logical switch automatically configuring third party solutions in the distributed network to meet the requirements for the virtual components of the distributed network comprises the logical switch directly configuring third party solutions by communicating with the third party solutions using native third party solution protocols.

6. The method of claim 5, wherein communicating with third party solutions using third party solution protocols comprises the logical switch communicating using a plug-in at the logical switch that enables the plug-in to communicate directly with third party solutions in third party solution's native protocol.

7. The method of claim 5, wherein communicating with third party solutions using third party solution protocols comprises the logical switch communicating directly with third party solutions using APIs exposed by the third party solutions.

8. The method of claim 1, wherein the third party solution comprises a TOR switch.

9. In a distributed computing environment, a system for configuring third party solutions to operate with virtual machines in a distributed network environment, the system comprising:
one or more processors; and
one or more computer readable media, wherein the one or more computer readable media comprise computer executable instructions that when executed by at least one of the one or more processors cause the system to perform the following:
receiving information at a logical switch about third party solutions in a distributed network;
receiving information at the logical switch about requirements for virtual components of the distributed network; and
the logical switch automatically configuring third party solutions in the distributed network to meet the requirements for the virtual components of the distributed network.

10. The system of claim 9, wherein receiving information at a logical switch about third party solutions in a distributed network is performed by the logical switch communicating with the third party solutions and the third party solutions providing the information about the third party solutions directly to the logical switch.

11. The system of claim 9, wherein receiving information at a logical switch about third party solutions in a distributed network is performed by the logical switch receiving configuration metadata from a network administrator.

12. The system of claim 9, wherein receiving information at the logical switch about requirements for virtual components of the distributed network comprises receiving information about requirements for virtual components of the distributed network in requirement metadata from a network administrator.

13. The system of claim 9, wherein the logical switch automatically configuring third party solutions in the distributed network to meet the requirements for the virtual components of the distributed network comprises the logical switch directly configuring third party solutions by communicating with the third party solutions using native third party solution protocols.

14. The system of claim 13, wherein communicating with third party solutions using third party solution protocols comprises the logical switch communicating using a plug-in at the logical switch that enables the plug-in to communicate directly with third party solutions in third party solution's native protocol.

15. The system of claim 13, wherein communicating with third party solutions using third party solution protocols comprises the logical switch communicating directly with third party solutions using APIs exposed by the third party solutions.

16. The system of claim 9, wherein the third party solution comprises a TOR switch.

17. A physical computer readable storage media, wherein the physical computer readable storage media comprises computer executable instructions that when executed by at least one or more processors causes the following to be performed:
receiving information at a logical switch about third party hardware solutions in a distributed network;
receiving information at the logical switch about requirements for virtual components of the distributed network; and
the logical switch automatically configuring third party solutions in the distributed network to meet the requirements for the virtual components of the distributed network by communicating with the third party solutions using native third party solution protocols using APIs exposed by the third party solutions.

18. The computer readable medium of claim 17, wherein receiving information at a logical switch about third party solutions in a distributed network is performed by the logical switch communicating with the third party solutions and the third party solutions providing the information about the third party solutions directly to the logical switch.

19. The computer readable medium of claim 17, wherein receiving information at a logical switch about third party solutions in a distributed network is performed by the logical switch receiving configuration metadata from a network administrator.

20. The computer readable medium of claim 17, wherein the third party solution comprises a TOR switch.
